(19) United States
(12) Patent Application Publication
(10) Pub. No.: US 2026/0004022 A1
(43) Pub. Date: Jan. 1, 2026

(54) METHOD FOR OPTIMIZING TUBULAR RUNNING OPERATIONS USING MODELLING

(71) Applicant: NOETIC TECHNOLOGIES INC., Edmonton (CA)

(72) Inventors: C. John VAN VLIET, Calgary (CA); Spencer TAUBNER, Edmonton (CA); Victor YUNG, Edmonton (CA)

(21) Appl. No.: 19/132,357

(22) PCT Filed: Jan. 3, 2025
(86) PCT No.: PCT/CA2025/050008

§ 371 Date: May 22, 2025

Related U.S. Application Data
(60) Provisional application No. 63/618,145, filed on Jan. 5, 2024.

(51) Int. Cl. G06F 30/20; E21B 47/007; G06F 119/14

(52) U.S. Cl. CPC G06F 30/20; E21B 47/007; G06F 2119/14

(57) ABSTRACT

A method for optimizing tubular running operations (TROs) on a drilling rig calculates a surface load limit of a running string, using each of one or more selected modelled kinematic conditions as input to torque-and-drag analysis (TDA) in the bottom-up direction to estimate a running string load distribution including an estimated load acting at the top of the running string, and for each selected component of the running string calculating a load buffer, identifying a limiting load buffer from among the calculated load buffers, calculating a surface load buffer based on the limiting load buffer, and calculating the surface load limit based on the surface load buffer. TROs may be optimized by taking steps as necessary to keep actual loads applied to the upper end of the running string within surface load limits. Optionally, TDA in the top-down direction may be iteratively performed to determine revised surface load limits.

### FIELD

The present disclosure relates in general to methods and systems for reducing or minimizing the duration of tubular running operations (TROs) for wells such as but not limited to oil or gas wells, and for extending the depth reachable by tubular strings during TROs, while ensuring that stresses and strains imposed on the components of the tubular strings are maintained at acceptable levels during TROs, and relates in particular to such methods and systems for use in association with deviated wellbores.

### BACKGROUND

Deviated wells are commonly used in the extraction of hydrocarbons from subterranean formations. In contrast with vertical wells, deviated wells are intentionally drilled at an angle to the vertical along some or all of their length where advantageous to the hydrocarbon extraction process. Some deviated wells run horizontally through thin hydrocarbon-bearing formations to increase the contact area between the wells and the formation and, in turn, to increase the production that can be achieved from a single well. In other cases, a deviated well is used to access a hydrocarbon-bearing formation where restrictions, physical or regulatory, prevent the drilling of a vertical well from directly above the formation.

During the construction of a well, it is typical to install one or more tubulars in the well (for example, to provide the borehole with structural stability, or to control the flow of hydrocarbons). In this context, the term “tubular” may be understood to refer to any type of pipe, including pipe commonly known as casing, liner, or tubing. Tubulars arrive at the wellsite as individual lengths known as joints, typically 6 to 15 metres (20 to 50 feet) in length. The joints are run into the well one after the other, with each joint being connected to the one below by a threaded connection, to form a string. The string may be cemented in place within the well, suspended from another tubular string using specialized downhole equipment, or suspended from the wellhead. The process of running a string into a well, or otherwise manipulating the position of a string within a well, is referred to in this patent document as a “tubular running operation” (or “TRO”), and the string involved in a tubular running operation is referred to as a “running string”.

In vertical wells, forces acting on the running string during a tubular running operation include gravity (i.e., the weight of the running string itself) and buoyancy, which results from the running string displacing fluid within the well. In deviated wells, the running string experiences additional forces resulting from contact with the wellbore. For purposes of this patent disclosure, the term “wellbore” is to be understood as referring to any outer tubular string or open-hole section that encloses any part of the running string during a tubular running operation.

Contact forces between a wellbore and a running string are referred to as side load. Side load may result from the running string resting on the low side of the wellbore, from tension or compression pulling or pushing the running string to the side of a curved wellbore (the “capstan effect”), from the bending stiffness of the running string through a curved wellbore, from sinusoidal or helical buckling of the running string within the wellbore, or from other effects. If the running string is moving, or if applied forces are urging it to move, then frictional forces arise to resist the movement, or attempted movement, of the running string.

The ratio of the frictional force magnitude to the associated side load magnitude is typically termed the friction factor (conceptually analogous to the friction coefficient associated with contact between two surfaces). Different friction factors may apply for different running string components and wellbore types. Frictional forces may act in the axial direction (either uphole or downhole), in the rotational direction, or in some intermediate direction. More complex mechanisms or downhole conditions may also result in forces being applied to the running string. Examples include, but are not limited to, differential sticking, ledges, and obstructions.

During the installation of a tubular string in a deviated well, the frictional forces on the string act to impede its progress into the well. Without friction or other opposing forces, the full vertical weight of the running string would be suspended from the derrick of the drilling rig. To overcome friction, the driller must “slack off” or reduce the portion of the running string's weight supported by the derrick. If the running string is unable to advance into the well under its own weight, then the driller may use progressively more extreme measures to advance the string. For example, the driller may set down the weight of rig equipment (such as a top drive) on the running string. A pull-down system may be employed to pull the top of the running string down. The running string may also be rotated to “break friction” so that the frictional forces are partially oriented in the rotational direction rather than purely in the axial direction. Regardless of the measures employed, the loads applied to the running string must be carefully managed to avoid overloading the components of the running string.

Every component in a running string has physical load limits beyond which the component will be damaged. The load limits may be expressed in terms of axial force (tension or compression), torque, side load, internal and/or external pressure, curvature, or some combination of these variables. The range of loads that can be safely applied to a component is defined by a load limit envelope, which in the most general sense is a multi-dimensional shape considering all the loads mentioned above. In practice, the load limit envelope may be expressed as a set of limit curves on a plot of axial force against torque, with each limit curve corresponding to a different curvature and pressure condition. A component's load limit envelope may be described using equations, experimental data points, or analysis data points. A component may have multiple sub-components, each with its own load limit envelope. In such cases, the component load limit envelope is the combination of the sub-component load limit envelopes such that no sub-components are overloaded.

To facilitate the monitoring, management, and optimization of rig operations, modern drilling rigs are equipped with an array of sensors. On many rigs, the readings from the various sensors are fed to a central data acquisition system known as the electronic data recorder or electronic drilling recorder (“EDR”). Important measurements during tubular running operations include the block height, the insertion depth of the running string, the force and torque applied to the top of the running string, the running rate (i.e., axial velocity) and rotation rate of the running string, and the pressure, flow rate, density, and temperature of fluids in the well during the tubular running operation. In this context, the term “insertion depth” corresponds to the term “measured depth” as defined in the “Schlumberger Oilfield Glossary”—i.e., the length of the running string along its path (which only corresponds to a depth below ground in vertical wells).

The axial force on the top of the running string is often inferred from the drilling rig hook load, which is commonly determined by measuring the tension in the deadline of the rig's hoisting system. Although this method is convenient, its accuracy is affected by friction in the hoisting system. Therefore, the axial force on the top of the running string is occasionally measured by placing a load cell directly above the string. Such a load cell is commonly packaged in a component called a torque-and-tension sub, which also contains instrumentation to measure the torque applied to the string. More commonly, the applied torque is inferred from the hydraulic or electric power supplied to the drilling rig top drive. The drilling rig's block height measurement is commonly used during tubular running to determine: (1) the running rate, based on the rate of change of the block height; and (2) the insertion depth, based on the cumulative block movement.

While the sensors on modern drilling rigs provide the rig crew with valuable information on the conditions at surface, direct measurements of downhole conditions are generally not available during tubular running operations. Downhole sensors are commonly used during drilling to measure such things as the azimuth and inclination of the wellbore, and the torque and axial force near the drill bit. Such sensors can be used in one or more discrete locations during certain types of tubular running operations; however, their high cost typically precludes their use within any part of the running string left in the well, since the sensors would also be left in the well. Therefore, while it is simple to measure the torque and axial force applied to the top of the running string during a tubular running operation, it is not feasible to measure the torque and axial force applied to each component of the running string downhole. Without direct measurements, it is challenging to determine whether any component of the running string has been overloaded.

The challenges associated with drilling and completing deviated wells have spurred the development of analysis methods known as torque-and-drag analysis (“TDA”). TDA of a tubular running operation involves calculating the loads acting on discrete elements in the running string due to gravity, buoyancy, side loads, and frictional forces. Typically, TDA is performed in the bottom-up direction where load and motion boundary conditions are applied to the bottom of the running string and TDA provides an estimate of the torque and axial force distribution along the running string and at the top of the running string at surface. For example, typical boundary conditions during tubular running would be zero load at the bottom of the running string while moving with prescribed running and rotation rates. TDA may also be performed in the top-down direction where load and motion boundary conditions are applied to the top of the running string.

Different types of torque-and-drag models are available, including “soft-string” models that neglect the bending stiffness of the pipe, and “stiff-string” models that account for bending stiffness to varying levels of technical rigour. TDA is usually performed prior to well construction while designing a well or planning drilling or tubular running operations. TDA may be supplemented with fluid flow models for estimating downhole pressures, rates, and temperatures of fluids in the well.

### BRIEF SUMMARY OF THE DISCLOSURE

The present disclosure describes embodiments of methods and systems for determining a safe limit for the load that may be applied by a drilling rig to the upper end of a running string (“surface load limit”) during a tubular running operation (TRO) involving the installation or manipulation of the running string in a wellbore. The surface load limit is calculated to maintain the estimated loads on selected components of the running string within load limits specified for those components. A plurality of surface load limits may be calculated to generate a surface load limit envelope. The tubular running operation may be optimized by applying load to the upper end of the running string that approaches but does not exceed the surface load limit (or surface load limit envelope, as the case may be). In this disclosure, references to “optimizing” a tubular running operation are to be understood as meaning reducing or minimizing the duration of the tubular running operation and/or extending the depth reachable by the running string during a tubular running operation, while ensuring the loads imposed on selected components of the running string are maintained at acceptable levels.

Non-limiting examples of uses for a surface load limit (or surface load limit envelope, as the case may be) calculated in accordance with the present disclosure include:
Tubular running operations involving jointed tubulars (i.e., individual tubular lengths joined together by threaded connections) wherein the loads on the running string are at risk of approaching or exceeding the loads limits of the threaded connections.
Tubular running operations involving the use of flotation to reduce the magnitude of the frictional forces on the running string. In such tubular running operations, part or all of the running string is filled with air rather than drilling fluid, and the air-filled section of the running string can be subjected to high net external pressure that increases the risk of a structural failure of the running string.
Tubular running operations involving the installation of sand control systems, flow control devices, or other sensitive components into a well. Such components can have reduced load limits relative to standard tubular joints, and their performance during operation of the well may be adversely impacted if their load limits are exceeded during the installation process.

In tubular running operations such as those mentioned above, methods and systems in accordance with the present disclosure can be used to identify one or more limiting components of the running string (i.e., one or more components of the running string at greatest risk of being overloaded) and to determine a surface load limit (or surface load limit envelope) that will ensure the load limits of the limiting component(s) are not exceeded. The surface load limit (or surface load limit envelope) is expressed in terms of the load acting at the upper end of the running string, and can be readily related to measurable rig loads such as the hook load and applied torque. This allows the surface load limit (or surface load limit envelope) to be easily interpreted by field personnel at the wellsite, enabling optimization of the tubular running operation through the application of load to the upper end of the running string that might approach but does not exceed the surface load limit (or surface load limit envelope).

Unlike methods and systems described in the prior art, the present methods and systems do not require measurement of the insertion depth of the running string in the wellbore, running rate of the running string, rotation rate of the running string, or load acting at the top (i.e., upper end) of the running string when determining a surface load limit (or surface load limit envelope). Instead, the present methods and systems use torque-and-drag analysis to infer the relationship between the load acting at the top of the running string and the kinematics (i.e., running rate and rotation rate) of the running string. This allows surface load limits to be pre-calculated for a range of kinematic conditions in advance of a tubular running operation.

In one aspect, the present disclosure describes embodiments of a method for optimizing a tubular running operation in which a running string is disposed in a wellbore at a wellsite, said method comprising the steps of:
selecting one or more kinematic conditions of the running string, wherein each selected kinematic condition includes an insertion depth of the running string, a running rate of the running string, and a rotation rate of the running string; and
in respect of each selected kinematic condition:
   performing a torque-and-drag analysis in the bottom-up direction, using the kinematic condition as input to the torque-and-drag analysis, to estimate a running string load distribution, including an estimated load acting at the top of the running string;
   calculating a load buffer for each of one or more selected components of the running string, based on a local load limit envelope of the component and an estimated load on the component as indicated by the running string load distribution;
   identifying a limiting load buffer from among the load buffers of all selected components of the running string;
   calculating a surface load buffer based on the limiting load buffer; and
   calculating a surface load limit based on the surface load buffer.

In some embodiments, the above-noted “performing”, “calculating”, and “identifying” steps may be carried out by means of one or more suitably-configured processors.

In one variant embodiment of the method, the load buffer of each selected component of the running string for each selected kinematic condition is calculated based on the assumption that the direction of the load buffer of each selected component is parallel to the direction of an estimated motive load at surface.

In another variant embodiment of the method:
if the load buffer of at least one of the selected components of the running string is a negative load buffer, the negative load buffer having the largest magnitude is identified as the limiting load buffer; and
if the load buffers of all of the selected components of the running string are positive load buffers, the positive load buffer having the smallest magnitude is identified as the limiting load buffer;
   and the surface load buffer optionally may be assumed to be equal to the limiting load buffer.

In a further variant embodiment of the method, the load buffer of each selected component of the running string for each selected kinematic condition may be calculated based on the assumption that the direction of the load buffer of a given selected component is parallel to the direction of an estimated motive load on that selected component. In this variant embodiment, the limiting load buffer may be identified by the steps of:
calculating a motive load ratio for each selected component of the running string;
identifying a specific selected component of the running string having the largest motive load ratio; and
identifying as the limiting load buffer, the load buffer corresponding to the specific selected component identified above.
   In this further variant embodiment, the surface load buffer optionally may be calculated based on the motive load ratio of the component having the limiting load buffer.

In another variant embodiment of the method, the surface load limit for each selected kinematic condition may be calculated as the sum of the surface load buffer and the estimated load at the top of the running string.

Optionally, the method may further comprise the following steps in respect of each of the one or more selected kinematic conditions:
performing torque-and-drag analysis in the top-down direction using the selected kinematic condition and the surface load limit as input to the torque-and-drag analysis, to estimate a revised running string load distribution;
calculating a revised load buffer for each selected component of the running string, based on the local load limit envelope of the component and a revised estimated load on the component as indicated by the revised running string load distribution;
identifying a revised limiting load buffer from among the revised load buffers of all of the selected components of the running string;
calculating a revised surface load buffer based on the revised limiting load buffer;
calculating a revised surface load limit based on the revised surface load buffer; and
iterating the preceding five (5) steps until one or more user-selected convergence criteria are satisfied.

In one particular optional variant of the method, only one kinematic condition is selected, and the method comprises the further the steps of:
measuring, by means of one or more sensors, an actual load acting at the top of the running string; and
adjusting the actual load acting at the top of the running string so that the actual load acting at the top of the running string remains within the surface load limit of the selected kinematic condition.

In another particular optional variant of the method, a plurality of kinematic conditions (rather than one or more kinematic conditions) may be selected, the insertion depth is the same for all of the plurality of selected kinematic conditions, and the method comprises the further step of connecting the surface load limits of the plurality of selected kinematic conditions on a plot of axial force against torque to obtain a surface load limit envelope. In this variant method, the surface load limits of the plurality of selected kinematic conditions may be connected using interpolation, curve fitting, or any other suitable method.

In a further particular optional variant of the method, the method comprises the further steps of:
measuring, by means of one or more sensors, an actual load acting at the top of the running string; and
adjusting the actual load acting at the top of the running string so that the actual load acting at the top of the running string remains within the surface load limit envelope.

In this embodiment of the method, the step of adjusting the actual load acting at the top of the running string comprises one or more steps selected from the group consisting of:
changing an actual torque applied to the top of the running string;
changing an actual axial force applied to the top of the running string (e.g., an actual hook load or an actual pull-down force);
changing an actual running rate of the running string;
changing an actual rotation rate of the running string;
adding a lubricant to the wellbore;
adding centralizers to the running string; and
pulling the running string out of the wellbore to perform wellbore cleaning.

In another aspect, the present disclosure describes embodiments of a system for implementing the methods described above, with the system comprising one or more processors configured to perform the steps in respect of each selected kinematic condition:
performing a torque-and-drag analysis in the bottom-up direction, using the kinematic condition as input to the torque-and-drag analysis, to estimate a running string load distribution, including an estimated load acting at the top of the running string;
calculating a load buffer for each of one or more selected components of the running string, based on a local load limit envelope of the component and an estimated load on the component as indicated by the running string load distribution;
identifying a limiting load buffer from among the load buffers of all selected components of the running string;
calculating a surface load buffer based on the limiting load buffer; and
calculating a surface load limit based on the surface load buffer.

In one variant embodiment of the system, at least one of the one or more processors may be configured to identify the limiting load buffer by the steps of:
calculating a motive load ratio for each selected component of the running string;
identifying a specific selected component of the running string having the largest motive load ratio; and
identifying as the limiting load buffer, the load buffer corresponding to the specific selected component identified above.

In other variant embodiments of the system, at least one of the one or more processors may be configured:
to calculate the surface load buffer based on the motive load ratio of the component having the limiting load buffer;
to calculate the surface load limit for each selected kinematic condition as the sum of the surface load buffer and the estimated load at the top of the running string; and/or:
to perform one or more of the following further steps in respect of each of the one or more selected kinematic conditions:
   performing torque-and-drag analysis in the top-down direction using the selected kinematic condition and the surface load limit as input to the torque-and-drag analysis, to estimate a revised running string load distribution;
   calculating a revised load buffer for each selected component of the running string, based on the local load limit envelope of the component and a revised estimated load on the component as indicated by the revised running string load distribution;
   identifying a revised limiting load buffer from among the revised load buffers of all of the selected components of the running string;
   calculating a revised surface load buffer based on the revised limiting load buffer;
   calculating a revised surface load limit based on the revised surface load buffer; and
   iterating the preceding five (5) steps until one or more user-selected convergence criteria are satisfied.

Optionally, any of the above-described system embodiments may also comprise one or more sensors for measuring an actual load acting at the top of a running string.

### BRIEF DESCRIPTION OF THE DRAWINGS

Embodiments in accordance with the present disclosure will now be described with reference to the accompanying Figures, in which numerical references denote like parts, and in which:

FIG. 1 is a flow chart indicating steps generally corresponding to first and second exemplary embodiments of a method in accordance with the present disclosure.

FIG. 2 illustrates a local load limit envelope and estimated load for an illustrative running string component that has a positive load buffer.

FIG. 3 illustrates a local load limit envelope and estimated load for an illustrative running string component that has a negative load buffer.

FIG. 4 conceptually illustrates a running string disposed in a deviated wellbore at a wellsite in an example tubular running operation (TRO), with the running string extending to the surface S and having a component A, located in a horizontal section of the wellbore, and a component B, located in a curved section of the wellbore.

FIG. 5 illustrates the axial force component of the running string load distribution in the example TRO conceptually illustrated in FIG. 4.

FIG. 6 illustrates the torque component of the running string load distribution in the example TRO.

FIG. 7 illustrates the local load limit envelope of component A of the running string and the estimated load on said component in the example TRO.

FIG. 8 illustrates the local load limit envelope of component B of the running string and the estimated load on said component in the example TRO.

FIG. 9 illustrates a method for determining the estimated motive load at surface.

FIG. 10 illustrates a method for determining the load buffer of component A of the running string in the example TRO, wherein the load buffer is calculated in a direction parallel to the estimated motive load at surface.

FIG. 11 illustrates a method for determining the load buffer of component B of the running string in the example TRO, wherein the load buffer is calculated in a direction parallel to the estimated motive load at surface.

FIG. 12 illustrates a method for calculating a surface load limit in the example TRO.

FIG. 13 illustrates an alternative method for determining the load buffer of component A of the running string in the example TRO, wherein the load buffer is calculated in a direction parallel to the estimated motive load on component A.

FIG. 14 illustrates an alternative method for determining the load buffer of component B of the running string in the example TRO, wherein the load buffer is calculated in a direction parallel to the estimated motive load on component B.

FIG. 15 is a flow chart indicating steps of an exemplary embodiment of a method in accordance with the present disclosure, incorporating an iterative solution strategy.

FIG. 16 shows an example of a plurality of kinematic conditions that could be selected to calculate a plurality of surface load limits.

FIG. 17 shows a plurality of surface load limits calculated based on a plurality of kinematic conditions and a resulting surface load limit envelope.

FIG. 18 is a flow chart indicating steps of a variant embodiment of the method depicted in FIG. 1.

### DETAILED DESCRIPTION

### First Exemplary Embodiment: Surface and Component Load Buffers are Parallel

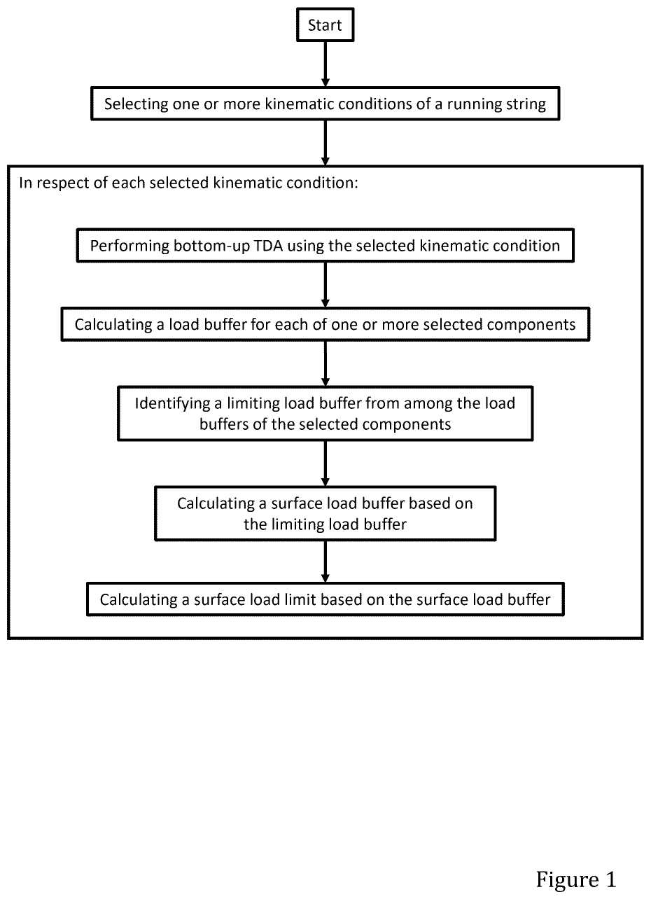

FIG. 1 is a flow chart indicating steps generally corresponding to a first exemplary embodiment of a method of optimizing a tubular running operation (TRO) in accordance with the present disclosure. As a first step in the method, at least one kinematic condition is selected for analysis. As used in the present disclosure, the term “kinematic condition” denotes a combination of modelling values of operational parameters of a tubular running operation including the insertion depth, running rate, and rotation rate of a running string:

$$K = \{ L , ω , v \}$$

where K is a kinematic condition;
   L is a modelling value of the insertion depth of the running string;
   ω is a modelling value of the rotation rate of the running string; and
   v is a modelling value of the running rate of the running string.

As used in the present disclosure, the term “modelling value” denotes a user-selected value of a user-selected operational parameter for purposes of torque-and-drag analysis. Accordingly, “kinematic conditions”, associated operational parameters (such as, but not limited to, insertion depths, rotation rates, and running rates), and loads are by default “modelled kinematic conditions”, “modelled operational parameters”, and “modelled/estimated/predicted loads” except where explicitly indicated otherwise. For convenience and brevity, express and implicit references hereinafter to values of operational parameters of a tubular running operation (including but not limited to insertion depths, rotation rates, and running rates) and loads are to be understood as meaning modelling values, unless such values are expressly referred to as (or the context clearly implies that they are) “actual” values associated with a running string involved in a tubular running operation in process on a well site (as distinct from “modelling” values).

The kinematic condition may be selected to represent a kinematic condition encountered or expected to be encountered during a tubular running operation. The insertion depth of the running string must greater than zero, and at least one of the running rate and the rotation rate of the running string must be non-zero. The rotation rate (and therefore the torque along the length of the running string) will most commonly be zero or positive, but can also be negative. For conventional oilfield tubular strings made up of pipe joints with right-hand threaded connections, a positive value for rotation rate denotes right-hand rotation, and a positive value for torque denotes right-hand torque; similarly, a negative value for rotation rate denotes left-hand rotation, and a negative value for torque denotes left-hand torque.

Using methods known to persons of ordinary skill in the art, torque-and-drag analysis (TDA) is performed in the bottom-up direction to estimate a running string load distribution. Modelling values of the running string insertion depth, running rate, and rotation rate of the selected kinematic condition are used as inputs to the TDA. The running string load distribution describes the distribution of axial force and torque along the length of the running string (i.e., expresses axial force and torque as a function of axial position along the running string). The running string load distribution may additionally describe the distribution of other load components along the length of the running string as may be relevant to the tubular running operation being analyzed, such as:
bending associated with curvature of the wellbore trajectory,
bending associated with buckling of the running string within the wellbore,
internal and external pressures acting on the running string,
side load, and
temperature.

If the rotation rate of the selected kinematic condition is zero, the estimated torque along the length of the running string will typically be zero.

Components of the running string to be considered in the calculation of the surface load limit are selected for analysis. Any number of components of the running string may be selected for analysis. However, only a subset of the components of the running string might be at risk of being overloaded for some tubular running operations, and in such cases only this subset might be selected for analysis.

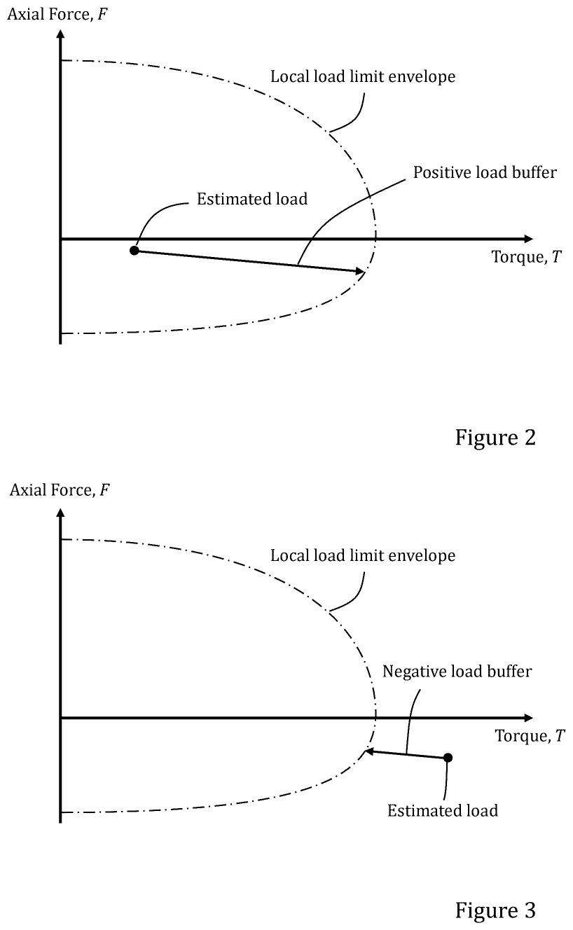

The load limits of each selected component of the running string may be expressed as a local load limit envelope on a plot of axial force against torque (for example, as shown in FIGS. 2 and 3). A component's local load limit envelope may describe its capacity to withstand combinations of torque and axial force in the presence of other load components, including bending associated with curvature of the wellbore trajectory, bending associated with buckling of the running string, internal pressure, external pressure, side load, and temperature. Load limits data for the selected components of the running string can be obtained using methods known to persons of ordinary skill in the art, such as engineering calculations, finite element analysis (FEA), and physical testing. Expressing the load limits of each selected component of the running string as a local load limit envelope may involve interpolation of the available load limits data based on the estimated loading state of each selected component.

The running string load distribution determined from TDA gives an estimate of the load at the top of the running string; however, this load estimate generally will not correspond to a surface load limit. The running string load distribution might indicate that the estimated loads on all selected components of the running string are within load limits (i.e., additional load can be safely applied at surface), or it might indicate that the estimated load on one or more of the selected components of the running string exceeds load limits (i.e., the estimated load at the top of the running string exceeds a safe surface load limit). An incremental load is therefore sought that, when added to the estimated load at the top of the running string, will bring the estimated load on each selected component of the running string within or coincident with each component's local load limit envelope. This incremental load is termed the “load buffer at surface” and represents the incremental load that can be safely applied to the top of the running string while also keeping the estimated load on each selected component of the running string from exceeding the component's local load limit. The load buffer at surface has torque and axial force components and may be represented in vector notation as:

$${P}_{buffer @ S} = \{ {T}_{buffer @ S} , {F}_{buffer @ S} \}$$

where P_{buffer@S} is the load buffer at surface;
   T_{buffer@S} is the torque component of the load buffer at surface; and
   F_{buffer@S} is the axial force component of the load buffer at surface.
   P_{buffer@S} and other loads with torque and axial force components can be visualized as vectors on a plot of axial force against torque. Such loads will be referred to as “vector loads” for the purposes of the present disclosure, and vector concepts such as direction and magnitude—as well as standard definitions for vector addition, subtraction, and scalar multiplication—will be applied. It should be noted, however, that the torque and axial force components of P_{buffer@S} and other such loads have dissimilar units.

The load buffer at surface may be determined from its direction and magnitude. To establish the direction of the load buffer at surface, a motive load at surface is first obtained from the running string load distribution. As used in the present disclosure, the term “motive load” refers to a vector load with torque and axial force components that urges motion of the running string, and whose direction governs the direction of the motion of the running string. The axial force component of the motive load is termed the “motive force”, and the torque component of the motive load is termed the “motive torque”. The estimated motive force at surface is calculated as the difference between the estimated axial force at the top of the running string, given by the running string load distribution, and the buoyed hanging weight of the running string at the top of the running string:

$${F}_{motive @ S} = {F}_{S} - {F}_{weight @ S}$$

where F_{motive@S} is the estimated motive force at surface;
   F_{S} is the estimated axial force at the top of the running string; and
   F_{weight@S} is the buoyed hanging weight of the running string at the top of the running string.

The buoyed hanging weight of the running string is defined as the axial force distribution that would occur along a stationary running string in a hypothetical scenario with gravity and no friction between the running string and the wellbore. Methods for calculating the buoyed hanging weight of the running string will be known to persons of ordinary skill in the art. In the simple case of a running string of uniform geometry and uniform material density, with fluid of uniform density inside the running string and throughout the wellbore, the buoyed hanging weight of the running string at the top of the running string can be calculated according to the following formula:

$${F}_{weight @ S} = b m g {d}_{L}$$

where b is called the buoyancy factor;
   m is the mass per unit length of the running string;
   g is the acceleration due to gravity (approximately 9.81 m/s²); and
   d is the true vertical depth of the wellbore at the bottom of the running string.

The buoyancy factor accounts for the reduction in the apparent weight of the running string due to buoyancy, and can be calculated for the simple case above using the following equation:

$$b = 1 - \frac{{ρ}_{fluid}}{{ρ}_{running string}}$$

where β_{fluid} is the density of the fluid inside the running string and within the wellbore; and
   β_{running string} is the density of the material from which the running string is made.

In more complex cases—for example, where the geometry and/or material density of the running string are non-uniform—the buoyed hanging weight of the running string can be calculated using numerical methods whereby the running string is analyzed in multiple sections. The buoyed hanging weights of all sections are calculated and then combined to produce the buoyed hanging weight of the entire running string.

The estimated motive torque at surface is simply the estimated torque at the top of the running string given by the running string load distribution:

$${T}_{motive @ S} = {T}_{S}$$

where T_{motive@S} is the estimated motive torque at surface; and
   T_{S} is the estimated torque at the top of the running string.
      The estimated motive load at surface is thus:

$${P}_{motive @ S} = \{ {T}_{motive @ S} , {F}_{motive @ S} \}$$

If the direction of the motive load at surface were to change, the kinematic condition of the running string would generally also change. Therefore, it is assumed that the direction of the motive load at surface must remain constant for the selected kinematic condition. This assumption requires that the direction of the load buffer at surface be the same as the direction of the estimated motive load at surface. The direction of the load buffer and estimated motive load may be defined by a motive direction ratio:

$${r}_{motive @ S} = \frac{{F}_{motive @ S}}{{T}_{motive @ S}} = \frac{{F}_{buffer @ S}}{{T}_{buffer @ S}}$$

where r_{motive@S} is the motive direction ratio at surface.

To determine the magnitude of the load buffer at surface, a load buffer for each selected component of the running string is first determined to assess the proximity of the estimated load on each selected component to each selected component's local load limit envelope. A component's load buffer may be represented as a vector on a plot of axial force against torque. It begins at the point denoting the estimated torque and axial force on the component, given by the running string load distribution, and terminates at the component's local load limit envelope. In this first embodiment, the load buffer of each selected component of the running string is assumed to have a direction parallel to the load buffer at surface (and, therefore, parallel to the motive load at surface) based on an assumption that any change in the load applied to the top of the running string will result in an equal change in the load applied to the selected component.

The ratio of the axial force and torque components of the load buffer of each selected component of the running string is thus equal to the motive direction ratio at surface:

$$\frac{{F}_{buffer @ i}}{{T}_{buffer @ i}} = {r}_{motive @ S}$$

where T_{buffer@i} is the torque component of the load buffer of component i; and
   F_{buffer@i} is the axial force component of the load buffer of component i.

A component's load buffer is deemed to be positive if the point denoting the estimated torque and axial force on the component is contained within the local load limit envelope, and negative if the point denoting the estimated torque and axial force on the component falls outside the local load limit envelope.

FIG. 2 shows a local load limit envelope and estimated load for an illustrative running string component. The estimated load is contained within the local load limit envelope of the component; therefore, the component load buffer is deemed to be positive. FIG. 3 shows an example in which the estimated load on an illustrative running string component falls outside the local load limit envelope of the component, and the component load buffer is deemed to be negative.

The magnitude of a component load buffer may be calculated according to the following equation:

$$‖ {P}_{butfer @ i} ‖ = \sqrt{{( {T}_{buffer @ i} )}^{2} + {( {F}_{buffer @ i} )}^{2}}$$

where P_{buffer@i} is the load buffer of component i;
   T_{buffer@i} is the torque component of P_{buffer@i};
   F_{buffer@i} is the axial force component P_{buffer@i}; and
   ∥P_{buffer@i}∥ denotes the magnitude of P_{buffer@i}.

Once the load buffer of each selected component of the running string has been calculated, a limiting load buffer is identified. In this first embodiment, the limiting load buffer is identified based on the magnitudes of the load buffers of the selected components of the running string. If the load buffer of one or more of the selected components of the running string is negative (i.e., the point denoting the estimated torque and axial force is outside the local load limit envelope), then the limiting load buffer is identified as the negative load buffer with the largest magnitude. Otherwise, the load buffers of all the selected components of the running string are positive or zero (i.e., for each selected component, the point denoting the estimated torque and axial force is inside or coincident with the local load limit envelope) and the limiting load buffer is identified as the load buffer with the smallest magnitude. As a matter of convention, a load buffer having a magnitude of zero is considered to be a positive load buffer for purposes of the present disclosure.

Once the limiting load buffer has been identified, the load buffer at surface is calculated. In this first embodiment, the load buffer at surface is equal to the limiting load buffer. This approach is based on the assumption that any change in the load acting at the top of the running string will result in an equal change in the load acting on the limiting component, which tends to be a good approximation in cases where there is little friction acting on the running string between the top of the running string and the location of the limiting component.

Once the load buffer at surface has been determined, a surface load limit is calculated as the sum of the estimated load at surface, given by the running string load distribution, and the load buffer at surface:

$${P}_{limit @ S} = {P}_{S} + {P}_{buffer @ S}$$

where P_{limit@S} is the surface load limit; and
   P_{S} is the estimated load at the top of the running string.

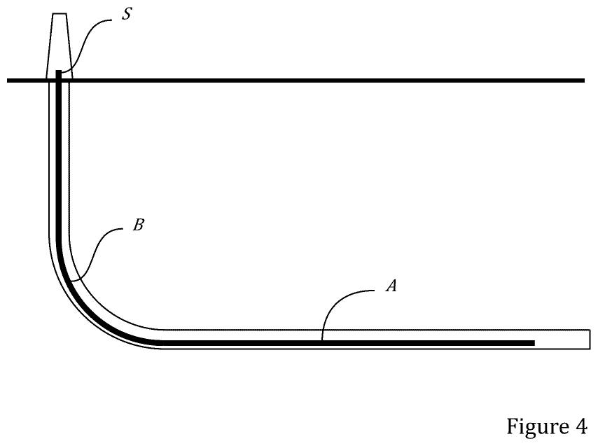

FIGS. 4 through 12 illustrate the calculation of a surface load limit for an example tubular running operation involving the installation of a running string in a wellbore, as depicted in FIG. 4. Torque and axial force are applied by a drilling rig to the top S of the running string. The running string includes component A, located in a horizontal section of the wellbore, and component B, located in a curved section of the wellbore.

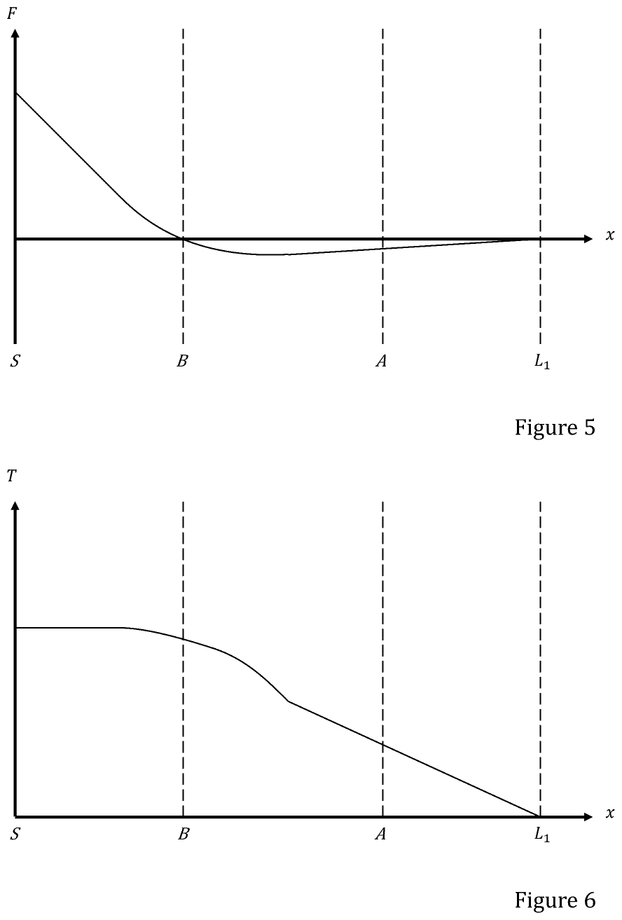

A kinematic condition K₁ describing the insertion depth, running rate, and rotation rate of the running string (L₁, v₁, and ω₁, respectively) is selected for analysis. Using the insertion depth, running rate, and rotation rate of the selected kinematic condition as inputs, bottom-up TDA is performed to estimate a running string load distribution. The running string load distribution includes an axial force component, whose distribution along the length of the running string is shown in FIG. 5, and a torque component, whose distribution is shown in FIG. 6. Annotations S, A, and B along the measured depth axes of FIG. 5 and FIG. 6 correspond to the like-named components in FIG. 4.

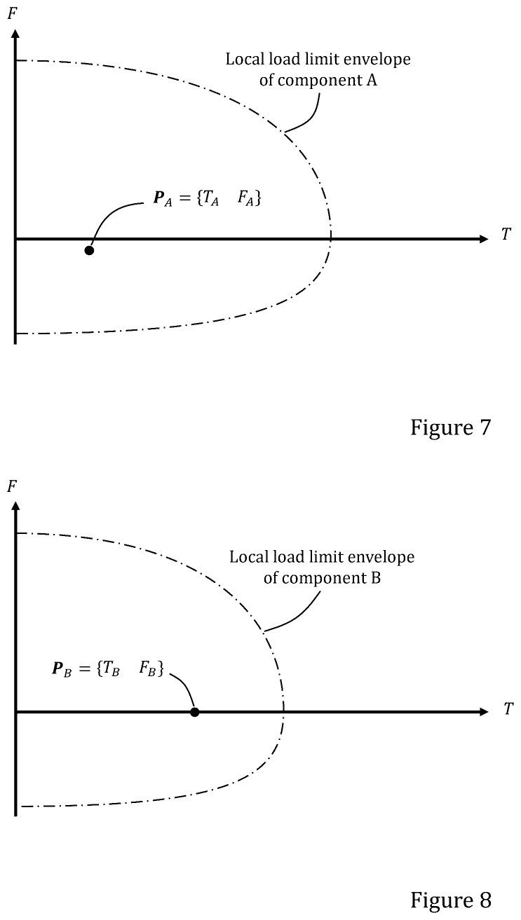

In the present example, components A and B of the running string are at risk of being overloaded during the tubular running operation. These components are therefore considered in the calculation of the surface load limit. Based on load limits data obtained using methods known to persons of ordinary skill in the art, a local load limit envelope is calculated for each of component A and component B describing each component's capacity to withstand torque and axial force given other estimated loads acting on the component. FIG. 7 shows the local load limit envelope for component A, as well as the estimated torque and axial force on component A given by the running string load distribution, denoted by point P_{A}. The local load limit envelope for component B is shown in FIG. 8 alongside the estimated torque and axial force on component B, denoted by point P_{B}.

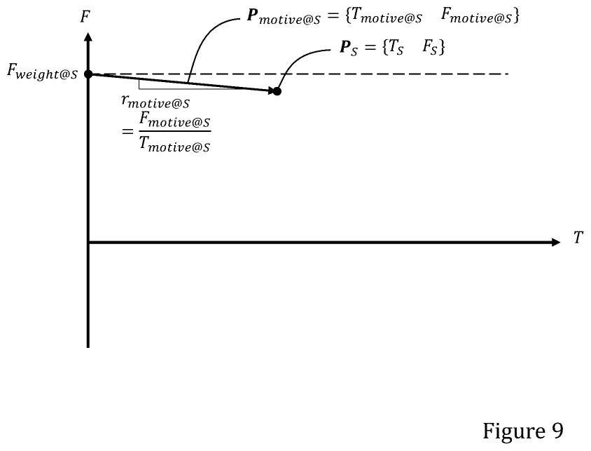

The estimated loads on components A and B are contained within the local load limit envelopes of the components, indicating that additional load can safely be applied to the running string. A load buffer at surface P_{buffer@S} is sought that describes the maximum additional load that can be applied to the top of the running string while keeping the estimated loads on components A and B within load limits. To determine the direction of the load buffer at surface, the estimated motive load at surface P_{motive@S} is first calculated based on the buoyed hanging weight of the running string F_{weight@S} and the estimated load at the top of the running string P_{S}, as shown in FIG. 9. Then, it is assumed that the direction of the motive load at surface must remain constant for the selected kinematic condition, which requires that the load buffer at surface be parallel to the estimated motive load at surface, or, in other words, that the direction of the load buffer at surface be defined by the motive direction ratio at surface r_{motive@S}.

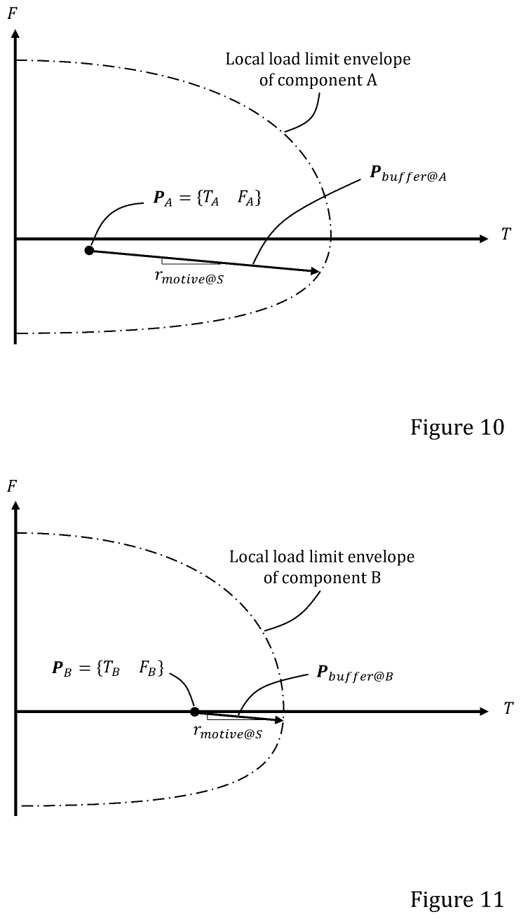

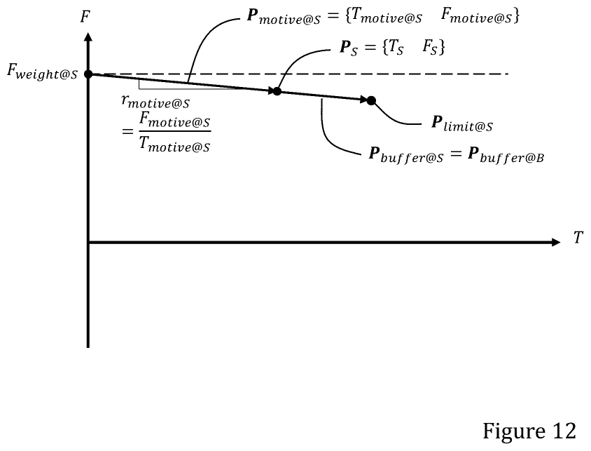

To determine the magnitude of the load buffer at surface, a load buffer is first calculated for each of component A and component B in the direction defined by the motive direction ratio at surface based on the assumption that any change in the load applied to the top of the running string will result in an equal change in the load experienced by each component. The load buffer of component A (P_{buffer@A}) is shown in FIG. 10, and the load buffer of component B (P_{buffer@B}) is shown in FIG. 11. Because the load buffers of both components are positive (i.e., the estimated loads are within load limits) and the magnitude of the load buffer of component B is less than that of component A, the load buffer of component B is identified as a limiting load buffer. The load buffer at surface is therefore assumed equal to the load buffer of component B. A surface load limit is calculated as the sum of the estimated load at the top of the running string and the load buffer at surface, as shown in FIG. 12.

### Second Exemplary Embodiment: Alternative Load Buffer Calculation

Alternative embodiments may employ different approaches for calculating the load buffer at surface without deviating from the scope of the present disclosure.

In the first exemplary embodiment, the load buffer of each selected component of the running string was calculated to be parallel to the motive load at surface based on the assumption that any change in the load applied to the top of the running string will result in an equal change in the load experienced by each selected component. An alternative assumption is that the direction of the motive load acting on each selected component of the running string will remain constant as the load applied to the top of the running string varies for the selected kinematic condition. The two assumptions are equivalent when the direction of the motive load is constant along the length of the running string, but differ when the direction of the motive load varies, which can occur, for example, when the diameter of the running string is non-uniform.

In a second exemplary embodiment of a method in accordance with the present disclosure, the load buffer of each selected component of the running string is calculated in a direction parallel to the estimated motive load on the selected component. Like the estimated motive load at surface, the estimated motive load on a selected component of the running string is a vector load comprising a motive torque and a motive force:

$${P}_{motive @ i} = \{ {T}_{motive @ i} , {F}_{motive @ i} \}$$

where P_{motive@i} is the motive load on component i;
   T_{motive@i} is the motive torque on component i; and
   F_{motive@i} is the motive force on component i.

In the calculation of the motive force on a selected component, only the buoyed hanging weight of the portion of the running string below (i.e., downhole of) the selected component is considered:

$${F}_{motive @ i} = {F}_{i} - {F}_{weight @ i}$$

where F_{motive@i} is the estimated motive force on component i;
   Fᵢ is the estimated axial force on component i;
   F_{weight@i} is the buoyed hanging weight of the running string below component i.

The motive torque on a selected component of the running string is simply the estimated torque on the selected component given by the running string load distribution:

$${T}_{motive @ i} = {T}_{i}$$

where T_{motive@i} is the estimated motive torque on component i; and
   Tᵢ is the estimated torque on component i.

The direction of the estimated motive load on each selected component of the running string may be defined by a motive direction ratio for each selected component:

$${r}_{motive @ i} = \frac{{F}_{motive @ i}}{{T}_{motive @ i}}$$

where r_{motive@i} is the motive direction ratio of component i.

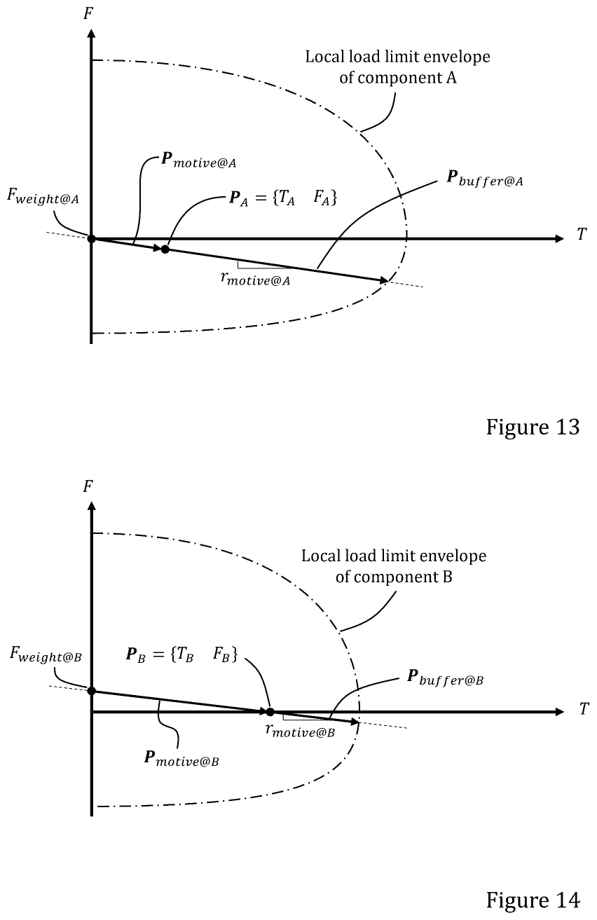

Considering the example tubular running operation introduced previously (and corresponding to FIG. 4 through FIG. 9), FIG. 13 and FIG. 14 illustrate the determination of the load buffers for components A and B, respectively, based on the assumption that the load buffer of each component is parallel to the estimated motive load on the component. Each load buffer begins at the point denoting the estimated torque and axial force on the component, given by the running string load distribution, and terminates at the component's local load limit envelope.

Since the load buffers of the selected components of the running string might not all be in the same direction, the load buffers should not be directly compared based on their magnitude (to identify a limiting load buffer), because the torque and axial force components of the load buffers have dissimilar units. Accordingly, in this second exemplary embodiment, the limiting load buffer is identified as the load buffer of the component with the largest estimated motive load ratio, where the “motive load ratio” of a component is the ratio of the estimated motive load on the component to the load limit of the component in the direction of the estimated motive load:

$${γ}_{motive @ i} = \frac{‖ {P}_{motive @ i} ‖}{‖ {P}_{motive @ i} + {P}_{buffer @ i} ‖}$$

where Y_{motive@i} is the motive load ratio of component i; and
   P_{buffer@i} is the load buffer of component i in the direction of P_{motive@i}.

Comparing load buffers on the basis of motive load ratio eliminates dependency on the unit set employed because each component load vector is with respect to the component load limit in the direction of the estimated component motive load.

In the first exemplary embodiment, the surface load buffer is equal to the limiting load buffer. This approach was based on the assumption that any change in the load applied at the top of the running string will result in an equal change in the load experienced by the limiting component, which tends to be a good approximation when there is little friction acting on the running string between surface and the location of the limiting component. An alternative assumption used in this second exemplary embodiment is that any change in the load applied at the top of the running string will result in a proportional change in the load acting on the limiting component. For example, using this approach, a 50% increase in the magnitude of the load applied at the top of the running string would be assumed to result in a 50% increase in the magnitude of the load experienced by each selected component of the running string.

Accordingly, in this second exemplary embodiment, the surface load buffer is calculated based on the motive load ratio of the component with the limiting load buffer according to the following equation:

$${P}_{buffer @ S} = \frac{{P}_{S}}{{γ}_{motive @ limiting}} - {P}_{S} = {P}_{S} ( \frac{1}{{γ}_{motive @ limiting}} - 1 )$$

$${γ}_{motive @ limiting} = max \{ {γ}_{motive @ i} \}$$

where γ_{motive@limiting} is the motive load ratio of the component with the limiting load buffer (i.e., largest motive load ratio).

This approach tends to work well when there is significant friction acting on the running string between surface and the location of the limiting component, such that only a fraction of any incremental load applied at the top of the running string reaches the limiting component.

### Third Exemplary Embodiment: Iterating to Improve the Accuracy of Surface Load Limit

The surface load limits calculated in the first and second exemplary embodiments are approximate because the running string load distribution on which a surface load limit is based will change as the load applied to the top of the running string approaches the surface load limit.

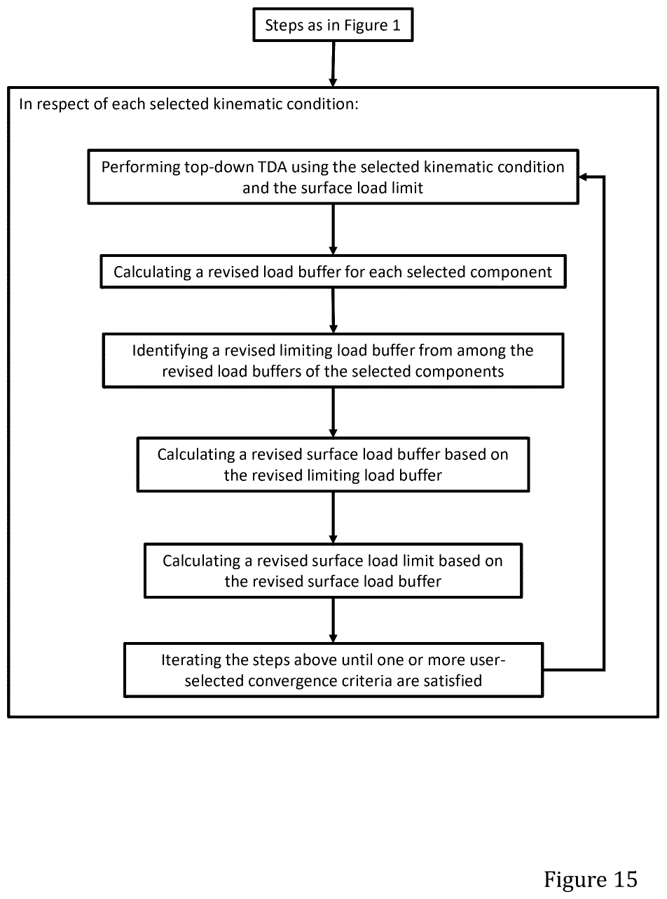

In a third exemplary embodiment of a method in accordance with the present disclosure, an iterative solution strategy is employed to improve the accuracy of the surface load limit. FIG. 15 is a flow chart listing steps of this third embodiment. Beginning with an estimate for the surface load limit (obtained using the steps shown in FIG. 1), TDA is performed in the top-down direction to obtain a revised running string load distribution representing the loading state of the running string if the load at the top of the running string were equal to the surface load limit. The axial force and torque components of the estimate for the surface load limit are applied as boundary conditions at the top of the running string in the top-down TDA, and the running string insertion depth, running rate, and rotation rate of the selected kinematic condition are used as inputs to the top-down TDA.

Based on the revised running string load distribution, a revised estimate for the surface load limit is calculated by repeating some of the steps previously described herein:
a revised load buffer is calculated for each selected component of the running string;
a revised limiting load buffer is identified; and
a revised load buffer at surface is calculated based on the revised limiting load buffer.

The revised estimate for the surface load limit is then calculated by multiplying the revised load buffer at surface by a user-specified mathematical relaxation coefficient, and adding the result to the existing estimated load at the top of the running string given by the revised running string load distribution. It should be noted that the estimated load at the top of the running string given by the revised running string load distribution is the prior estimate for the surface load limit, since this prior estimate was applied as the boundary condition at the top of the running string in the top-down TDA.

The revised estimate for the surface load limit can be used in successive calculations to further improve the estimate for the surface load limit until one or more user-specified convergence criteria are satisfied.

A load ratio of each selected component of the running string may be calculated with respect to the origin (i.e., the point denoting zero load on a plot of axial force against torque):

$${γ}_{i} = \frac{‖ {P}_{i} ‖}{‖ {P}_{i} + {P}_{buffer @ i} ‖}$$

where γᵢ is the load ratio of component i;
   Pᵢ is the estimated load on component i;
   P_{buffer@i} is the load buffer of component i in the direction of Pᵢ.

One possible convergence criterion is that the maximum load ratio among the selected components of the running string is sufficiently close to unity:

$$\vert {γ}_{max} - 1 \vert < ε$$

where γₘₐₓ is the maximum load ratio among the selected components; and
   ε is a user-specified convergence tolerance.

An alternative convergence criterion is that the magnitude of the most recent estimate for the limiting load buffer is acceptably close to zero:

$$‖ {P}_{buffer @ limiting} ‖ < ε$$

where P_{buffer@limiting} is the limiting load buffer;
   ∥P_{buffer@limiting}∥ denotes the magnitude of the limiting load buffer; and
   ε is a user-specified convergence tolerance.

Another possible convergence criterion is that the change in successive estimates for the surface load limit is acceptably small:

$$‖ {P}_{limit @ S}^{n} - {P}_{limit @ S}^{n - 1} ‖ < ε$$

where

$${P}_{limit @ S}^{n}$$

is the most recent estimate for the surface load limit;

$${P}_{limit @ S}^{n - 1}$$

is the estimate for the surface load limit from the previous iteration;

$$‖ {P}_{limit @ S}^{n} - {P}_{limit @ S}^{n - 1} ‖$$

denotes the magnitude of the difference between

$${P}_{limit @ S}^{n} and {P}_{limit @ S}^{n - 1} ;$$

and
ε is a user-specified convergence tolerance.

As described earlier, when an iterative solution scheme is employed, a user-specified relaxation coefficient may be used in calculating successive estimates for the surface load limit:

$${P}_{limit @ S} = {P}_{S} + {cP}_{buffer @ S}$$

where c is the relaxation coefficient.

The relaxation coefficient takes a positive value, typically between 0 and 2, and is intended to assist with solution convergence (i.e., reduce the number of iterations required to satisfy one or more convergence criteria). When the relaxation coefficient is set to 1, the load buffer at surface is simply added to the estimated load at the top of the running string to obtain the surface load limit. When the relaxation coefficient is set to a value other than 1, the magnitude of the load buffer at surface is increased or decreased before the load buffer at surface is added to the estimated load at the top of the running string, which may assist solution convergence.

In some embodiments, the relaxation coefficient may also be used in the calculation of the first estimate for the surface load limit.

### Fourth Exemplary Embodiment: Surface Load Limit Envelope

The preceding sections described embodiments that involved calculating a surface load limit corresponding to a selected kinematic condition, that is, a selected running string insertion depth, running rate, and rotation rate. In general, a tubular running operation involves a range of running string insertion depths, running rates, and rotation rates. Therefore, a range of surface load limits will typically be calculated to represent the range of conditions encountered or expected to be encountered during the tubular running operation.

In a fourth embodiment of a method in accordance with the present disclosure, surface load limits are calculated for multiple selected kinematic conditions with the same running string insertion depth but different running rates and/or rotation rates. The resulting surface load limits are connected on a plot of axial force against torque by means of interpolation or curve fitting to create a surface load limit envelope.

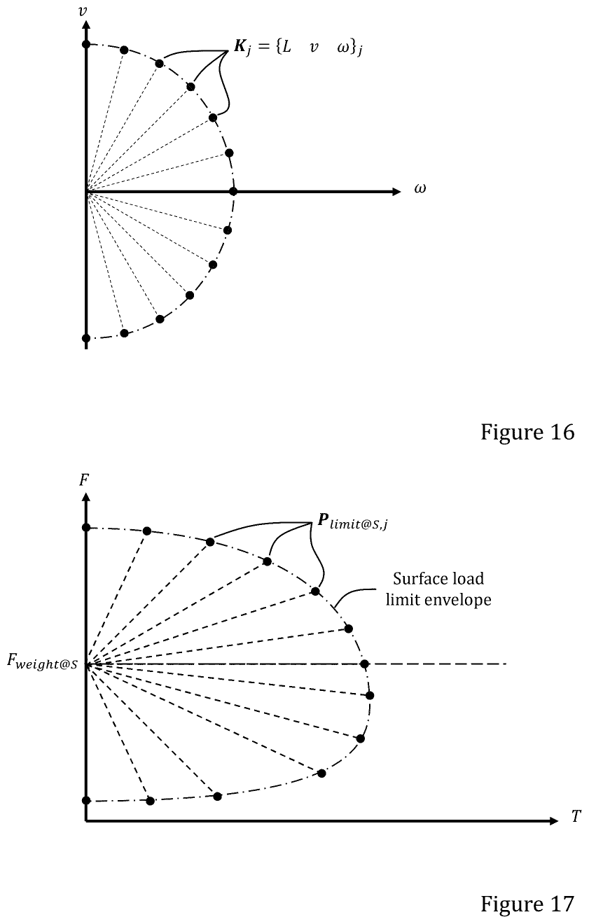

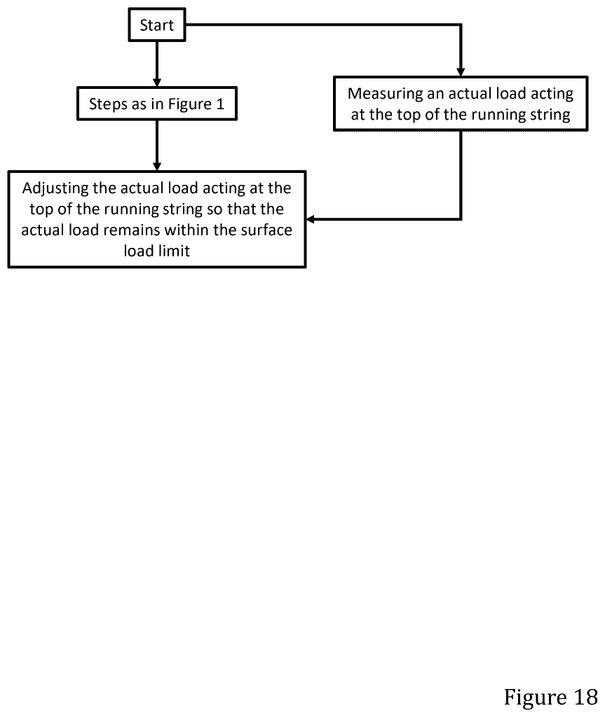

Aspects of one such embodiment are illustrated in FIG. 16 and FIG. 17. Multiple kinematic conditions with the same running string insertion depth (L) but different combinations of running rate (v) and rotation rate (ω) are selected for analysis. Each kinematic condition Kⱼ is represented by a point on a plot of running rate against rotation rate in FIG. 16. The kinematic conditions have been selected so that they span the range of possible directions of running string motion (i.e., the range of possible motive direction ratio values), including pure axial motion out of the well (positive running rate and zero rotation rate), pure rotation (zero running rate and non-zero rotation rate), and pure axial motion into the well (negative running rate and zero rotation rate). For each selected kinematic condition, a corresponding surface load limit is calculated. The resulting surface load limits are represented by points on a plot of axial force against torque in FIG. 17. Finally, the surface load limits are connected by means of interpolation or curve fitting to create a surface load limit envelope, which is denoted by the dash-dotted line in FIG. 17.

In a variant of this embodiment, the selected kinematic conditions encompass the range of possible motive direction ratio values at multiple running string insertion depths. A surface load limit envelope is calculated for each running string insertion depth.

### Fifth Exemplary Embodiment: Optimizing a Tubular Running Operation

The load applied to the top of the running during a tubular running operation can affect the success and efficiency of the tubular running operation. If insufficient load is applied to the top of the running string, the running rate may be limited, or the motion of the running string may stop altogether. Conversely, if excessive load is applied to the top of the running string, one or more components of the running string may be overloaded and sustain damage. A tubular running operation may be optimized by applying loads to the top of the running string that approach but do not exceed surface load limits.

Embodiments of a method in accordance with the present disclosure may additionally include the steps of:
measuring, by means of one or more sensors, an actual load acting at the top of the running string; and
adjusting the actual load acting at the top of the running string so that the actual load acting at the top of the running string remains within the surface load limit.

It will be readily appreciated by persons of ordinary skill in the art that various modifications to embodiments in accordance with the present disclosure may be devised without departing from the scope of the present teachings, including modifications which may use equivalent mathematical functions (i.e., functions having a different form than those mentioned herein but providing the same output for the same inputs).

It is to be especially understood that the scope of the present disclosure is not intended to be limited to described or illustrated embodiments and example data, and that the substitution of a variant of a claimed or illustrated element or feature, without any substantial resultant change in methodology, will not constitute a departure from the scope of the disclosure.

In this patent document, any form of the word “comprise” is to be understood in its non-limiting sense to mean that any element or feature following such word is included, but elements not specifically mentioned are not excluded. A reference to an element or feature by the indefinite article “a” does not exclude the possibility that more than one such element or feature is present, unless the context clearly requires that there be one and only one such element or feature. Where an element or feature is referred to herein as being “selected”, this is to be understood as meaning “user-selected”, unless the context implies otherwise.

Wherever used in this document, the terms “typical” and “typically” are to be interpreted in the sense of representative of common usage or practice, and are not to be understood as implying essentiality or invariability.

1. A method for optimizing a tubular running operation in which a running string is disposed in a wellbore at a wellsite, said method comprising the steps of:
(a) selecting one or more kinematic conditions of the running string, wherein each selected kinematic condition includes an insertion depth of the running string, a running rate of the running string, and a rotation rate of the running string;
(b) in respect of each selected kinematic condition:
(b.1) performing a torque-and-drag analysis in the bottom-up direction, using the kinematic condition as input to the torque-and-drag analysis, to estimate a running string load distribution, including an estimated load acting at the top of the running string;
(b.2) calculating a load buffer for each of one or more selected components of the running string, based on a local load limit envelope of the component and an estimated load on the component as indicated by the running string load distribution;
(b.3) identifying a limiting load buffer from among the load buffers of all selected components of the running string;
(b.4) calculating a surface load buffer based on the limiting load buffer; and
(b.5) calculating a surface load limit based on the surface load buffer.

2. The method as in claim 1 wherein the load buffer of each selected component of the running string for each selected kinematic condition is calculated based on the assumption that the direction of the load buffer of each selected component is parallel to the direction of an estimated motive load at surface.

3. The method as in claim 2 wherein:
(a) if the load buffer of at least one of the selected components of the running string is a negative load buffer, the negative load buffer having the largest magnitude is identified as the limiting load buffer; and
(b) if the load buffers of all of the selected components of the running string are positive load buffers, the positive load buffer having the smallest magnitude is identified as the limiting load buffer.

4. The method as in claim 3 wherein the surface load buffer is assumed to be equal to the limiting load buffer.

5. The method as in claim 1 wherein the load buffer of each selected component of the running string for each selected kinematic condition is calculated based on the assumption that the direction of the load buffer of a given selected component is parallel to the direction of an estimated motive load on that selected component.

6. The method as in claim 5 wherein the limiting load buffer is identified by the steps of:
(a) calculating a motive load ratio for each selected component of the running string;
(b) identifying a specific selected component of the running string having the largest motive load ratio calculated in step (a); and
(c) identifying as the limiting load buffer, the load buffer corresponding to the specific selected component identified in step (b).

7. The method as in claim 6 wherein the surface load buffer is calculated based on the motive load ratio of the component having the limiting load buffer.

8. The method as in claim 1 wherein the surface load limit for each selected kinematic condition is calculated as the sum of the surface load buffer and the estimated load at the top of the running string.

9. The method as in claim 1, further comprising the following steps in respect of each of the one or more selected kinematic conditions:
(a) performing torque-and-drag analysis in the top-down direction using the selected kinematic condition and the surface load limit as input to the torque-and-drag analysis, to estimate a revised running string load distribution;
(b) calculating a revised load buffer for each selected component of the running string, based on the local load limit envelope of the component and a revised estimated load on the component as indicated by the revised running string load distribution;
(c) identifying a revised limiting load buffer from among the revised load buffers of all of the selected components of the running string;
(d) calculating a revised surface load buffer based on the revised limiting load buffer;
(e) calculating a revised surface load limit based on the revised surface load buffer; and
(f) iterating steps (a) to (e) until one or more user-selected convergence criteria are satisfied.

10. The method as in claim 1, wherein:
(a) a plurality of kinematic conditions is selected;
(b) the insertion depth is the same for all of the plurality of selected kinematic conditions; and
(c) the method further comprises the step of connecting the surface load limits of the plurality of selected kinematic conditions on a plot of axial force against torque to obtain a surface load limit envelope.

11. The method as in claim 10 wherein the surface load limits of the plurality of selected kinematic conditions are connected using interpolation.

12. The method as in claim 10 wherein the surface load limits of the plurality of selected kinematic conditions are connected using curve fitting.

13. The method as in claim 1 wherein only one kinematic condition is selected, and further comprising the steps of:
(a) measuring, by means of one or more sensors, an actual load acting at the top of the running string; and
(b) adjusting the actual load acting at the top of the running string so that the actual load acting at the top of the running string remains within the surface load limit of the selected kinematic condition.

14. The method as in claim 10, further comprising the steps of:
(a) measuring, by means of one or more sensors, an actual load acting at the top of the running string; and
(b) adjusting the actual load acting at the top of the running string so that the actual load acting at the top of the running string remains within the surface load limit envelope.

15. The method as in claim 13, wherein the step of adjusting the actual load acting at the top of the running string comprises one or more steps selected from the group consisting of:
(a) changing an actual torque applied to the top of the running string;
(b) changing an actual axial force applied to the top of the running string;
(c) changing an actual running rate of the running string;
(d) changing an actual rotation rate of the running string;
(e) adding a lubricant to the wellbore;
(f) adding centralizers to the running string; and
(g) pulling the running string out of the wellbore to perform wellbore cleaning.

16. A system for implementing the method as in claim 1, said system comprising one or more processors configured to perform the steps in respect of each selected kinematic condition:
(a) performing a torque-and-drag analysis in the bottom-up direction, using the kinematic condition as input to the torque-and-drag analysis, to estimate a running string load distribution, including an estimated load acting at the top of the running string;
(b) calculating a load buffer for each of one or more selected components of the running string, based on a local load limit envelope of the component and an estimated load on the component as indicated by the running string load distribution;
(c) identifying a limiting load buffer from among the load buffers of all selected components of the running string;
(d) calculating a surface load buffer based on the limiting load buffer; and
(e) calculating a surface load limit based on the surface load buffer.

17. The system as in claim 16 wherein at least one of the one or more processors is configured to identify the limiting load buffer by the steps of:
(a) calculating a motive load ratio for each selected component of the running string;
(b) identifying a specific selected component of the running string having the largest motive load ratio calculated in step (a); and
(c) identifying as the limiting load buffer, the load buffer corresponding to the specific selected component identified in step (b).

18. The system as in claim 17 wherein at least one of the one or more processors is configured to calculate the surface load buffer based on the motive load ratio of the component having the limiting load buffer.

19. The system as in claim 16 wherein at least one of the one or more processors is configured to calculate the surface load limit for each selected kinematic condition as the sum of the surface load buffer and the estimated load at the top of the running string.

20. The system as in claim 16 wherein at least one of the one or more processors is configured to perform one or more of the following further steps in respect of each of the one or more selected kinematic conditions:
(a) performing torque-and-drag analysis in the top-down direction using the selected kinematic condition and the surface load limit as input to the torque-and-drag analysis, to estimate a revised running string load distribution;
(b) calculating a revised load buffer for each selected component of the running string, based on the local load limit envelope of the component and a revised estimated load on the component as indicated by the revised running string load distribution;
(c) identifying a revised limiting load buffer from among the revised load buffers of all of the selected components of the running string;
(d) calculating a revised surface load buffer based on the revised limiting load buffer;
(e) calculating a revised surface load limit based on the revised surface load buffer; and
(f) iterating steps (a) to (e) until one or more user-selected convergence criteria are satisfied.

21. The system as in claim 16, further comprising one or more sensors for measuring an actual load acting at the top of a running string.
